(19) United States
(12) Patent Application Publication
(10) Pub. No.: US 2007/0185785 A1
(43) Pub. Date: Aug. 9, 2007

(54) Location based creation of a catalog for a user

(76) Inventors: Michael Pierre Carlson, Austin, TX (US); Linda Arnold Lisle, Cedar Part, TX (US); Newton James Smith JR., Austin, TX (US); Clifford Jay Spinac, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/351,019

(22) Filed: Feb. 9, 2006

(51) Int. Cl. G06F 17/30

(52) U.S. Cl. 705/27

(57) ABSTRACT

A method of, and an apparatus and computer usable program code for, dynamically creating an electronic catalog for a user by a catalog provider. At the outset, the catalog is created by identifying a current location of the user and receiving a second location. The contents of the catalog are determined based on the locations. The format for presenting the catalog is determined based on the second location and attributes associated with the user. In response to identifying a change in the first location, the contents of the catalog are adjusted dynamically. Upon requesting checkout of an online shopping basket that contains items of selected catalog entries, the items in the shopping basket are identified as either available or not available for checkout, based on the current location of the requesting user. When a change is detected in the user's location, the contents of the online shopping basket are adjusted dynamically based on the changed location.

### BACKGROUND OF THE INVENTION

1. Field of the Invention

The present invention is related generally to an improved data processing system, and in particular, the present invention is directed to a method of, and a system and computer usable program code for, dynamically creating a catalog for a user.

2. Description of the Related Art

The retail industry has experienced a notable shift in the means of interacting with potential customers by using the web as a means of communication and effecting sales. It is nearly impossible to find even small retailers which do not have an online presence on the web. To expand the means for approaching potential customers, even brick and mortar retailers have devised complementary means to further offer their goods and services via the web, thus supplementing the traditional in-store sales floor with a kiosk for online catalog sales as well.

Having an online kiosk as an addition to the traditional store has enabled some retailers to offer other goods and services which may not be readily available in a local store due to limited shelf space or items being out of stock. Thus the online kiosk can provide a cost-effective means of saving labor costs and reducing floor space.

Potential customers also have experienced a significant shift in the manner of purchasing goods and services. Gone are the days when the paper catalog was the only means for shopping at a remote merchant. It is now typical for a customer to go online as a first step in order to comparison shop, read product reviews, and to assess retailer ratings via customer reviews, prior to the user making a purchase.

In expanding the means for approaching new customers, a retailer may place a kiosk for online catalog shopping at places where potential customers congregate, such as train stations, airport terminals, cruise ships, buses, airliners, and the like. The retailer envisions that a mobile, traveling customer also may be one with relatively high discretionary financial means, and may likely be one to shop while traveling.

Airline paper catalogs, for example, are being supplemented with electronic catalogs as a means of labor and fuel savings and as a convenience feature to the traveler. The content of paper and electronic catalogs reflect what a seller envisions a typical traveler will be interested in. In selecting the contents of either paper or electronic catalogs, airlines spend great time and effort in researching the interest level of the traveling customer, in anticipation that the browsing of their catalog will likely result in completing a sale. Thus, airlines and other transportation system providers have a need to refine the content of their catalogs such that in the limited time their catalog is available, the content will be of significant interest to the traveler.

As traditional merchants also compete for the traveler's business with 1) automated vending machines at airport terminals and boarding ramps, and 2) cabin sales and the like, it has become imperative that the contents of electronic catalogs are fine tuned even further with specific content of interest to the traveler.

### SUMMARY OF THE INVENTION

One aspect of the present invention provides a computer implemented method of, and a system and computer usable program code for, dynamically creating a catalog by a catalog provider for a user. A first location of a user is identified, and a second location is received by the catalog provider. A catalog is then dynamically created, wherein the catalog contents are determined based on the identified first location and the received second location. The catalog provider presents the dynamically created catalog in a format based on the received second location. The catalog provider adjusts the contents of the catalog responsive to detecting a change in the first location.

In addition, the present invention identifies at least one attribute associated with the user, and responsive to identifying the at least one attribute, the catalog provider adjusts the contents of the online catalog.

In another aspect, the present invention provides a computer implemented method of checkout of an online shopping basket by a service provider. The service provider identifies the current location of the user requesting checkout of an online shopping basket. Upon receiving by the service provider the request for checkout a determination is made whether at least one item in the shopping basket is available for checkout at the identified current location. The checkout of the online shopping basket is completed if at least one item is determined to be available for checkout at the current location.

In addition, the service provider determines whether at least one item in the shopping basket is not available for checkout, and responsive to that determination, an indication is created to indicate that at least one item in the shopping basket is not available for checkout, and the user may be informed with that indication. A calculation of all of the items in the online shopping basket and a calculation of the checkout amount of the items available for checkout at the current location are presented to the user. If a change is detected in the identified current location of the user, the contents of the shopping basket are adjusted based on the changed current location.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The novel features believed characteristic of the invention are set forth in the appended claims. The invention itself, however, as well as a preferred mode of use, including further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is an exemplary block diagram of a data processing system in which aspects of the present invention may be implemented;

FIG. 3 is an exemplary block diagram illustrating components used in creating a online catalog in accordance with an illustrative embodiment of the present invention;

FIG. 4 is an exemplary block diagram illustrating a master catalog database used in creating a catalog in accordance with an illustrative embodiment of the present invention;

FIG. 5 is an exemplary block diagram illustrating a user profile used in creating a catalog in accordance with an illustrative embodiment of the present invention;

FIG. 6 is an exemplary block diagram illustrating a location profile used in creating a catalog in accordance with an illustrative embodiment of the present invention;

FIG. 7 is an exemplary block diagram illustrating a travel profile used in creating a catalog in accordance with an illustrative embodiment of the present invention;

FIG. 8 is an exemplary catalog illustrating an online catalog created for a user with certain user attributes in accordance with an illustrative embodiment of the present invention;

FIG. 9 is an exemplary catalog illustrating an online catalog created for a user with other user attributes in accordance with an illustrative embodiment of the present invention;

FIG. 10 is an exemplary catalog illustrating an online catalog for a user with yet other user attributes in accordance with an illustrative embodiment of the present invention;

FIG. 11 is an exemplary shopping basket illustrating an online shopping basket of a user with certain user attributes in accordance with an illustrative embodiment of the present invention;

FIG. 12 is an exemplary shopping basket illustrating an online shopping basket of a user with other user attributes in accordance with an illustrative embodiment of the present invention;

FIG. 13 is a flowchart outlining an exemplary operation of the present invention by a catalog provider dynamically creating a location based catalog for a user in accordance with an illustrative embodiment of the present invention; and

FIG. 14 is a flowchart outlining an exemplary operation of the present invention when a request for checkout of an online shopping basket is received by a service provider in accordance with an illustrative embodiment of the present invention.

### DETAILED DESCRIPTION OF THE PREFERRED EMBODIMENT

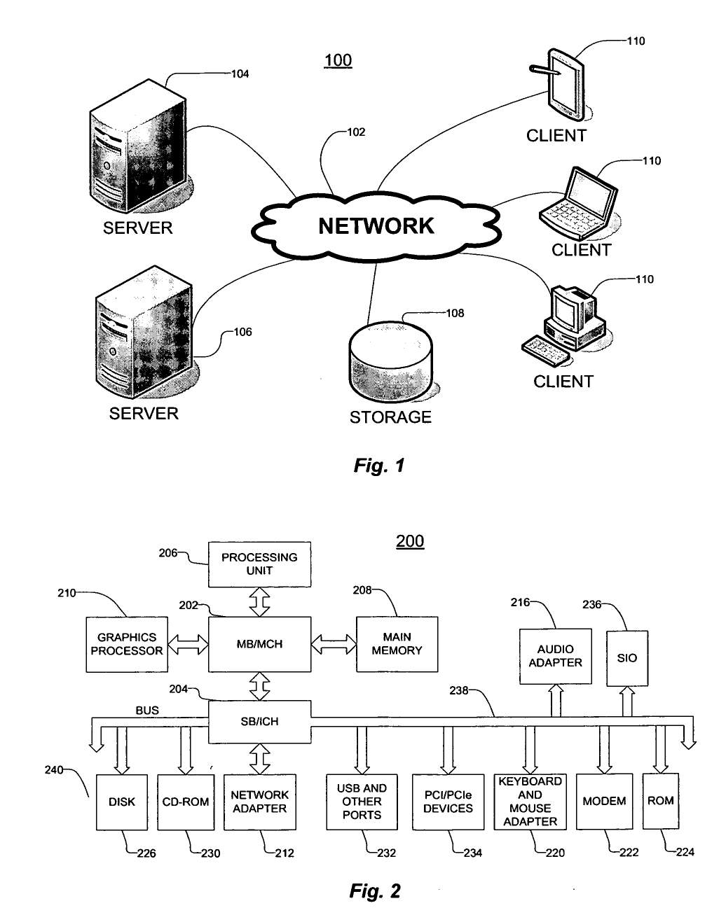

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. The aspects of the present invention can be implemented in network data processing system 100 to create an online catalog for a user. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wired or wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers.

In accordance with one embodiment of the present invention, a merchant with online catalog sales and services provides a server that is accessible by a user at a client. For example, a server for catalog sales and services is accessible to a user at a client to access a merchant's website that provides online catalogs. In accordance with the embodiments of the present invention, a client can be a computer located 1) on board an airliner, 2) at a user's home computer, 3) on a handheld computer such as a PDA, 4) on a phone carried by the user, or 5) at a computer based kiosk at an airport.

In the depicted example, server 104 provides data, such as boot files, operating system images, and applications, to clients 110, 112, and 114. Clients 110, 112, and 114 are clients to server 104 in this example. Network data processing system 100 may include additional servers, clients, and other devices not shown.

In the depicted example, server 106 provides data, such as catalog information, user related information, and location related information to clients 110, 112, and 114. Catalog related information includes one or more master catalog databases containing descriptions of items that can be included in online catalogs. User related information includes user location information, user profiles, and traveler profiles. Location related information includes location profiles. Server 106 may further include boot files, operating system images, and applications, to clients 110, 112, and 114. Clients 110, 112, and 114 are also clients to server 106 in this example. Network data processing system 100 may include additional servers, clients, and other devices not shown.

Clients 110 and 112, may be client computers used for presenting online catalogs, and client 114 may be an enterprise computer or a kiosk computer used for presenting online catalogs. Network data processing system 100 may include additional user clients, additional enterprise computers, additional kiosk computers, and other additional client devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230. Displays and keyboards may be connected to keyboard and mouse adapter 220 for interacting with a computer user. Printers may be connected to USB and other ports 232 for generating printed output. Speakers and microphones may be connected to audio adapter 216 for interacting with a computer user using an audio response system.

Those of ordinary skill in the art will appreciate that the hardware in FIGS. 1-2 may vary depending on the implementation.

In an illustrative embodiment, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 in FIG. 2. A memory may be, for example, main memory 208, ROM 224, or a cache such as may be found in NB/MCH 202 in FIG. 2. The depicted examples in FIGS. 1-2 and above-described examples are not meant to imply architectural limitations. For example, data processing system 200 also may be a tablet computer, laptop computer, kiosk computer, or telephone device.

The aspects of the present invention provide an improved method of, computer usable program code and system for, dynamically creating a catalog for a user, such as for a traveler. A transportation carrier typically provides paper catalogs for the passenger's convenience and to encourage purchasing goods and services while the passenger is on board. Merchants typically offer their goods and services in catalogs through marketing agreements with the carrier. Once the carrier reaches a stop or destination, travelers are encouraged to take the paper catalogs with them for subsequent shopping. A carrier is defined as a person, business, or organization that operates in the transportation of travelers by means of a carrier conveyance. A carrier conveyance is defined as a means to transport passengers. Examples of a carrier conveyance include an airplane, train, helicopter, bus, ship, boat, or any other means of passenger transport.

A computer based kiosk can also be used in an exemplary embodiment of the present invention. Computer based kiosks are typically placed at locations where large numbers of individuals congregate such as at airport terminals, bus depots, train stations, shopping malls, hospitals, sports facilities, convention centers, restaurants, and other similar gathering places. The computer based kiosk is typically connected to a server via a network or to other computers to facilitate catalog sales and services.

In an effort to further enable catalog sales and services, and to reduce labor and transportation expenses, carriers have turned to electronic catalogs as a means for presenting goods and services, thus reducing the expense of creating, distributing and carrying paper catalogs onboard. For example, airline carriers have created a further use of on-board passenger entertainment terminals by presenting online catalogs for use by the traveling public. Users of these catalogs also have benefited from this arrangement, wherein the electronic catalogs are used to present to the user detailed information about goods and services, wherein the detailed information is normally not feasible for presentation in paper catalogs. Using electronic catalogs enables a catalog provider to present goods and services to a user typically via an interactive interface such as a video display terminal coupled with a touch screen. The interface may include graphical renditions of catalog items, and may include audio and video clips demonstrating features and uses of items in the catalog.

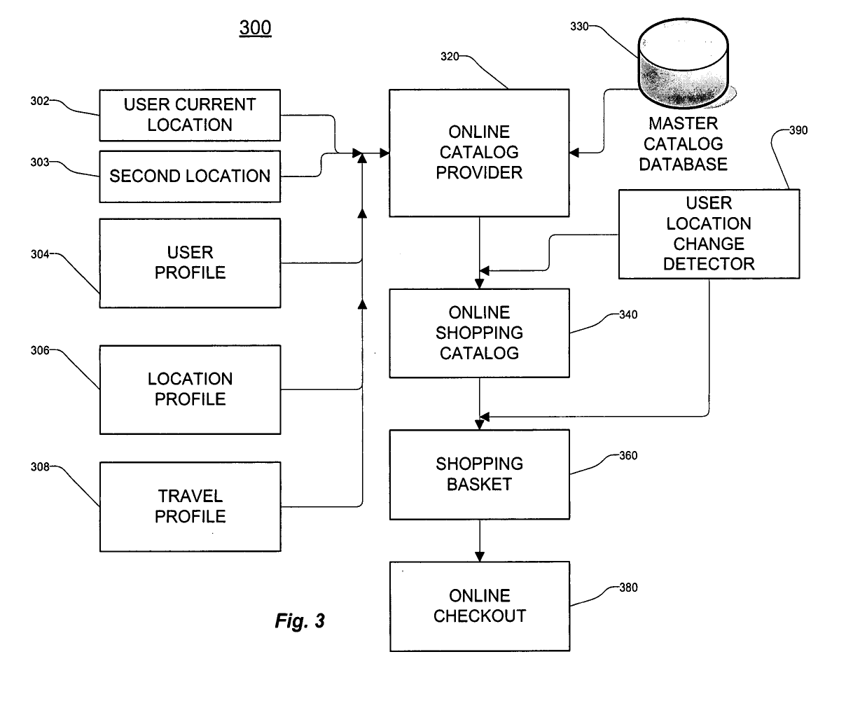

A user of an electronic catalog may select a product or service from a catalog such as online catalog 340 as described below with reference to FIG. 3. Upon selecting an item from the catalog for purchase, the selected item is stored in shopping basket 360 in FIG. 3. Upon completing all user selections, the user typically requests checkout of all items in the online shopping basket 360.

Using the present invention, the contents of the online catalog 340 in FIG. 3 are initially determined based on the catalog provider identifying a first location wherein the first location is the current location of the catalog user. The catalog provider then receives a second location 303 such as the intended location for checkout of a shopping basket. The second location can be provided by the user. The contents of the online shopping basket 360 in FIG. 3 are then adjusted according to the current location of the user and the received second location.

While the exemplary illustrative embodiment of the present invention presents a user making selections for purchase from an online catalog to store those selections in a shopping basket, any other action may be specified to store an item from a catalog in a shopping basket, and the exemplary purchase is not intended to limit the actions that may result in storing an item in a shopping basket. For example, making a request to rent a video DVD, to acquire a software license, or to receive a service, fall within the scope and spirit of the invention to store a catalog item in a shopping basket. The catalog provider may present all items, and may indicate those which are not available.

With reference to FIG. 3, the current location of a user 302 and the received second location 303 are used to determine the contents of an online catalog that may be presented to a user when creating the catalog. For example, a user traveling onboard an airliner from Vancouver, BC to Orlando, Fla. may be presented with an online catalog upon departure from Vancouver. At an intermediate stop in Toronto, the online catalog may be adjusted to show items that may be purchased by international travelers such as those bound for Orlando, or the online catalog may be adjusted to identify different prices for international travelers. Upon departure from Toronto, bound for Orlando, the online catalog may be changed automatically to denote a change in denomination from Canadian currency to United States currency.

A user profile 304 may be applied to determine what contents may be presented in an online catalog 340 when the catalog user is at user location 302. In one exemplary embodiment, user profile 304 is used by catalog provider 320 to identify certain user attributes. For example, a user of legal drinking age in Canada traveling from Vancouver to Toronto (e.g., a 19 year-old in Canada) may be presented with an online catalog that includes liquor selections. However, upon crossing the international border into the United States, the same user may not purchase the same liquor due to higher age restrictions (e.g., a 21 year-old in New York State). Thus, the online catalog is adjusted by removing certain items based on the attributes identified in a user's profile.

A location profile 306 may be applied by catalog provider 320 to determine any restrictions of items that may be presented in online catalog 340. The location profile 306 specifies restrictions that apply to items in the master catalog database 330 used by catalog provider 320 when creating catalog 340. The location profile 306 is unique to each user location 302 or received location 303, and may apply to a surrounding area within current user location 302 or received location 303, or to a vicinity within location 302 or location 303, or to a geographic area such as a city, county, state, or country, in which user location 302 or received location 303 is situated. The restrictions identified in location profile 306 correspond to any restrictions that must be applied by catalog provider 320 when creating online catalog 340. In an illustrative use of the exemplary embodiment, for instance at an intermediate stop in Toronto, the location profile 306 denotes location restrictions for items that may be presented in online catalog 340 while the user is in Toronto en-route to Orlando. Another location profile 306 is applied when building online catalog 340 for the traveler who makes an intermediate stop in Dallas, while en-route to Orlando.

A user's travel profile 308 may be applied by catalog provider 320 to determine the user's travel itinerary, thus identifying any other location profile 306 that may be further applicable when creating online catalog 340. In an exemplary embodiment, the travel profile 308 may include intermediate waypoints that may be reached by the traveler en-route to the traveler's final destination. The travel profile is used by the catalog provider 320 to inspect and further apply any restrictions identified in location profile 306 by adding or removing items presented in online catalog 340 as indicated by the identified restrictions.

FIG. 3 depicts an exemplary block diagram illustrating the components 300 used in creating an online catalog in accordance with an illustrative embodiment of the present invention. A user's location 302 is identified. The user's location 302 may be identified via commonly available user locator mechanisms. For example, in one exemplary embodiment, the user's location 302 may be identified for all passengers as the location of the carrier conveyance using a GPS based locator device. In another exemplary embodiment, the user's location 302 may be identified using a GPS locator device embedded in the user's mobile phone. Identifying a user's location 302 via GPS coordinates is well known to someone skilled in the art. In an exemplary embodiment, the user's identified location may be communicated to the carrier's catalog provider 320 running on network server 104 from client device 110 as depicted in FIG. 1, via a short range transmitter using the Bluetooth communications protocol.

In another exemplary embodiment, the user's location 302 is identified via a seat assignment database in storage device 108 as typically maintained by a carrier on server 106 as depicted in FIG. 1. The user's location may be communicated to catalog provider 320 by a service provider that maintains the seat assignment database for the carrier conveyance.

In another exemplary embodiment, the user's location 302 is identified via a kiosk location database in storage device 108. This location is typically maintained by a kiosk provider on server 106 when the user is operating kiosk computer 114 in FIG. 1. The kiosk's location may be communicated to catalog provider 320 by a service provider that maintains the kiosk location database and is used by the catalog provider to identify the current location 302 of the user.

Other exemplary means of identifying user location 302 may include using a radio frequency identification (RFID) tag associated with the user, or using a user's phone and a mobile phone locator maintained by a mobile phone carrier, wherein the location of the user's phone may be stored in a database in storage device 108 of server 106. Persons of ordinary skill in the art will appreciate that identifying a user's location may be accomplished using various locator means without departing from the spirit and scope of the invention.

In the exemplary embodiment, location 303 is received by catalog provider 320 when creating online catalog 340. A user such as an airline passenger may use an onboard passenger terminal 112 in FIG. 1, or a networked PDA client device 110 in FIG. 1 to specify location 303 to catalog provider 320. In the exemplary embodiment, location 303 is received by catalog provider in response to inspecting a user's travel itinerary, where the itinerary identifies a passenger's final destination, and the catalog provider uses the final destination as location 303.

Once the user's current location 302 is identified, and location 303 is received, the catalog provider 320 uses locations 302 and 303 to build catalog 340 using master catalog database 330. The master catalog database 330 may be stored on a computer such as server 106 in FIG. 1, and contains catalog entries with descriptions of all possible catalog items that may be presented to a user in online catalog 340. In an exemplary embodiment, catalog provider 320 uses the identified current user location 302 and location 303 to dynamically build online catalog 340 for the user by selecting items from the master database 330. The contents of online catalog 340 are tailored specifically to the user at the identified current user location 302 and received location 303, thus creating an online catalog 340 with only the contents from the master catalog database 330 which are deemed applicable to the identified user at location 302 and at received location 303. The catalog provider 320 may further use location 303 to customize the presentation of the catalog, and to process a request for checkout of an online shopping basket such that checkout 340 may only take place when the user is currently situated at the received location 303.

The user location change detector 390 is used to detect a change in the user's current location 302 such as when a traveler reaches a final destination. Catalog provider 320 receives a message identifying the change of the user's location from user location change detector 390. User location change detector 390 determines a change in the user's location by comparing the current user's location against a previous location 302 which may be stored in storage device 108 of server 106. Once a change is detected by location change detector 390, a new current user location 302 is stored in storage device 108 of server 106, and the location change detector 390 informs the catalog provider 320 of the new user location 302. In response to receiving a change in the user's location 302, catalog provider 320 adjusts the contents of the online catalog 340, and any item the user may have stored in online shopping basket 360 may also be adjusted as will be described below.

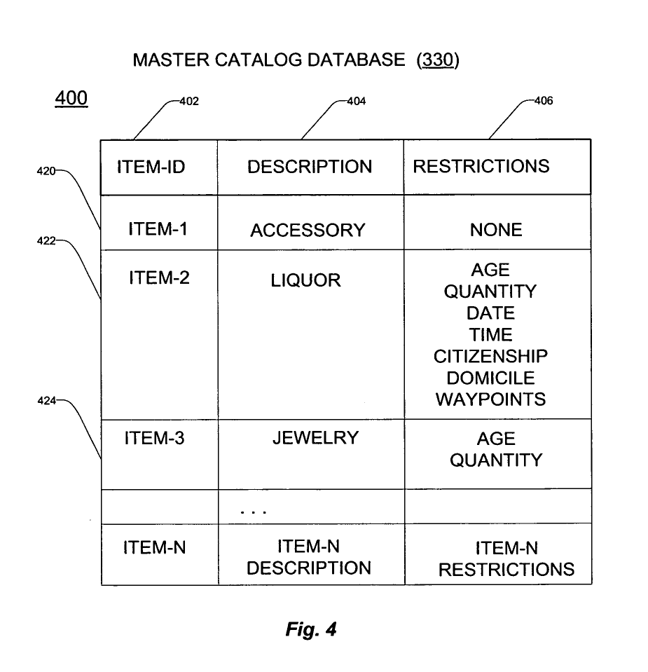

In an illustration using the exemplary embodiment of the present invention, regarding FIGS. 3 and 4, the master catalog database 330 may use exemplary format 400 specified in FIG. 4. The entries depicted in FIG. 4 comprise an illustrative embodiment of a master catalog database which includes a description of all items that may possibly be presented in an online catalog 340. The item identification (ITEM-ID) 402 in FIG. 4 may be used as a primary key in locating the item in database 330 stored on server 106 in FIG. 1. The item description 404 in FIG. 4 is used by catalog provider 320 to present a description of the catalog item in catalog 340 to the user at location 302. The master catalog database identifies any restrictions 406 in FIG. 4 that may be applicable when presenting an item from database 330 in online catalog 340. In the illustration of the exemplary embodiment, the entry for ITEM-1 420 has no restrictions for presenting the item in any online catalog 340. On the other hand, the entry for ITEM-2 422 includes a number of restrictions that must be applied when presenting online catalog 340 to user at location 302. In the illustrative example, catalog provider 320 determines whether ITEM-2 can be presented in online catalog 340 by 1) inspecting user profile 304 for possible user attribute restrictions such as age or domicile, 2) inspecting location profile 306 of user location 302 and received location 303 for any location restrictions such as quantity of items, or the date and time catalog items may be offered for sale, and 3) inspecting travel profile 308 to apply any possible restrictions identified using the knowledge of the user's current location 302 and any anticipated location 303 as listed in travel profile 308. For example, ITEM-2 422 identifies restrictions for presenting liquor in online catalog 340, wherein the listed restrictions 422 include 1) an age restriction, 2) a quantity restriction, 3) a date and time on which the item may not be presented in the catalog, 4) a citizenship restriction for presenting ITEM-2 to the user at current location 302 and at received location 303, 5) a domicile and residency restriction of the user identified with user profile 304 at location 302 and at received location 303, and 5) any restriction imposed by travel waypoints included in user's itinerary listed in travel profile 308.

In another illustrative example, ITEM-3 424 identifies restrictions that must be applied when presenting online catalog 340 by catalog provider 320, wherein age and quantity are listed as restrictions that must be applied.

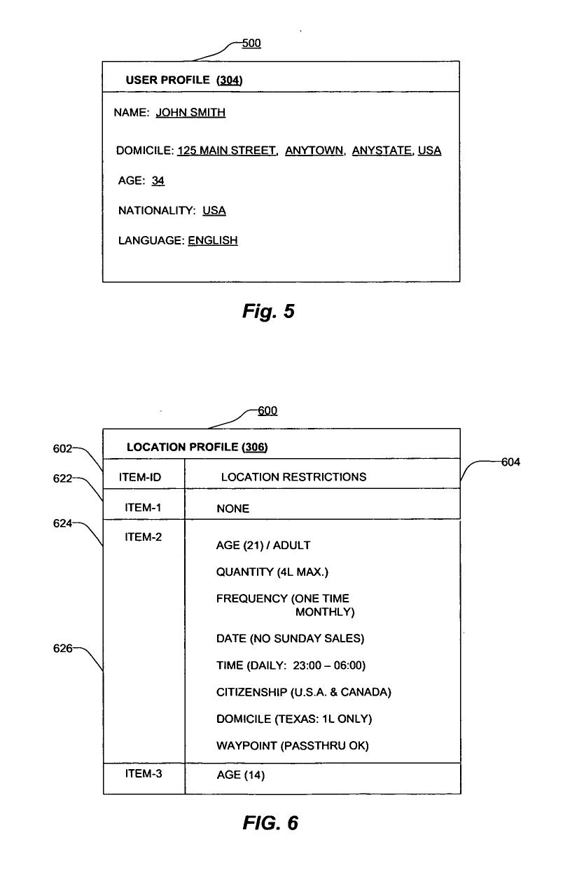

In an illustration using an exemplary embodiment of the present invention, FIG. 5 depicts a sample format 500 of user profile 304. The elements depicted in FIG. 5 comprise an illustrative embodiment of a user profile 304 that may be used by catalog provider 320 when creating catalog 340 using the items in master catalog database 330. The exemplary elements that comprise the user profile 304 are applied by catalog provider 320 to identify the user, and to identify user attributes in order to determine any restrictions that must be applied when creating online catalog 340. Exemplary attributes of user profile 304 as depicted in FIG. 5 include the user's name, domicile address, age, nationality, and spoken language. Other user attributes may be included in user profile 304 without departing from the scope and spirit of the invention. The catalog provider uses the information identified in user profile 304 to determine what items may be presented in online catalog 340. For example, ITEM-2 422 in FIG. 4 would not be presented in online catalog 340 to the catalog user if the age specified in the illustrative user profile 500 was 19 instead of 34, when location profile 306 restricts liquor sales to minors under 21 years old for users at current location 302. In addition, user profile 500 specifies English as the spoken language and is used by catalog provider 320 to present online catalog 340 in the illustrative example 500 to the user at location 302. If multiple languages are specified in the user profile, then the default language for location 302 may be used if at least one of the specified multiple languages matches the default language for location 302. This enables catalog provider 320 to create and present online catalogs to users in a preferred language and to dynamically change the language in which the created catalog is presented as the user's location 302 also changes. Thus, an online catalog for a bilingual Canadian traveler may initially be presented in French when in Montreal, and the catalog is automatically presented in English when in Toronto. If only one language is specified in user profile 304, then that language will be used for presenting catalog 340.

The location profile 306 specifies location restrictions that must be applied when creating online catalog 340. In the exemplary embodiment of the present invention, FIG. 6 depicts an exemplary location profile 306. The elements depicted in the exemplary location profile 600 may be used by catalog provider 320 when creating online catalog 340 using the entries in master catalog database 330. In the illustrative example, ITEM-1 622 identifies no restrictions, and may be presented in any catalog 340. ITEM-2 624 on the other hand, identifies age restrictions, wherein the user at location 302 identified via user profile 304 must be 21 years old in order for catalog provider 320 to present ITEM-2 624 in online catalog 340. Other exemplary restrictions illustrated in ITEM-2 624 include 1) a quantity restriction, 2) a frequency of purchase restriction, 3) a date and time restriction, 4) a citizenship restriction, 5) a residency and domicile restriction, and 6) any waypoint restriction. Thus, using the illustrative example, the catalog provider 340 creates and presents a catalog with ITEM-2 624 only to users over 21 years old on any day except Sunday, and only between the hours of 6:00 AM and 11:00 PM. Other restrictions may be included in exemplary illustration 600 of location profile 306 without departing from the spirit and scope of the invention.

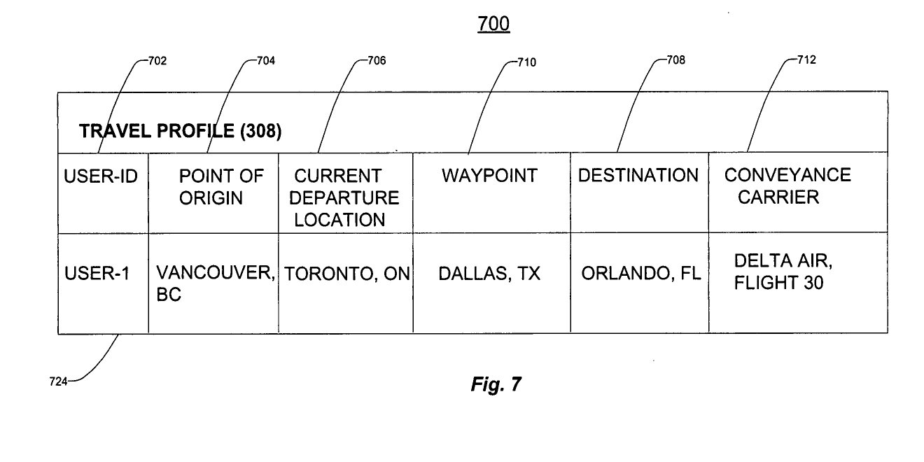

In an illustration using an exemplary embodiment of the present invention, FIG. 7 depicts an exemplary illustration 700 of travel profile 308. The elements depicted in travel profile 700 comprise an illustrative embodiment of a travel profile that may be used by catalog provider 320 when creating online catalog 340 using the items in master catalog database 330. The travel profile 308 identifies the itinerary of the user, such that the identified travel information is applied when creating online catalog 340 for user at current location 302 and any projected destinations 303. Exemplary elements in the user's travel profile 308 include 1) the user's identification 702, 2) the itinerary locations 303 of the user's travel plans 704, 706, 708 and 710, and 3) the conveyance carrier during travel 712. The catalog provider 320 uses the information specified in travel profile 308 to determine what items may be presented in online catalog 340 by applying the elements in the travel profile and any restrictions in location profile 306 for any catalog item listed in master catalog database 330. For example, USER-ID 702 identifies 1) the user, 2) the user's point of origin 704, 3) current departure point 706, 4) the intended destination 708, 5) any intermediate waypoints en-route to the destination 710, and 5) a description of the travel conveyance carrier 712. Any of the locations specified in travel profile 308 may be used as a received location 303. In the illustrative example 700, the travel profile of user USER-1 724 indicates the traveling user originating in Vancouver, currently stopped in Toronto, en-route to Orlando, stopping next at intermediate waypoint at Dallas, on flight 30 of designated carrier. The catalog provider 320 uses the information in the travel profile 308 to determine what items may be presented when creating online catalog 340. Catalog provider 320 uses the travel profile 700 information to identify location profiles 306 in order to determine any restrictions that must be applied at any portion of the travel itinerary such as at an intermediate waypoint and upon arriving at final destination. Therefore, the catalog provider 320 will not include in an online catalog 340 any item deemed restricted at the current user location 302 or at any location en-route to the final destination 708, or any item restricted by the carrier 712. For example, if fresh produce is included in location profile 306—not restricted for domestic travel—fresh produce may be included in online catalog 340 by catalog provider 320 to user at location 302 when traveling domestically from Vancouver to Toronto as destination. On the other hand, the online catalog for the user traveling internationally—restricted for international travel as specified in location profile 306—from Vancouver to Orlando, even with an intermediate stop in Toronto, the online catalog will not include the fresh produce entry in catalog 340, since travel profile 308 specifies the location profile 306 for Orlando which restricts fresh produce from being brought into the state by an international traveler.

The online catalog 340 may be presented to the user using the interface means of any client device 110, 112, and 114 as depicted in FIG. 1. In an exemplary embodiment, a graphical display is used to present catalog 340 to a user to interact with catalog 340 using a keyboard and a mouse or a touchscreen. Other means for presenting and using catalog 340 may include audio means such as spoken menu options in voice response systems. Those skilled in the art will appreciate that the presentation and interaction for selecting online catalog entries can take various other forms which do not depart from the scope and spirit of the invention. Thus, in one embodiment, a multimedia presentation may be used by catalog provider 320 to present online catalog 340 to a user at location 302.

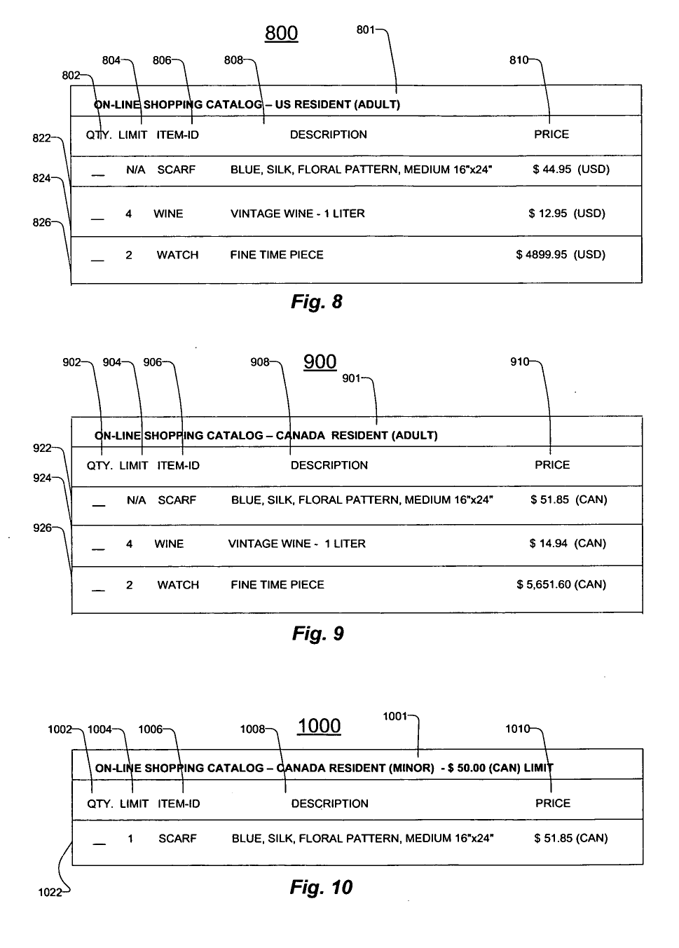

FIG. 8 depicts illustrative contents 800 of an online catalog 340 created for a user at current location 302, and any location 303. The exemplary catalog contents 800 of catalog 340 identify the user as an adult U.S. resident 801. An input field of the catalog entry enables the user to specify a quantity 802 of catalog item 806 in order to store the item in the user's shopping basket 360 in FIG. 3. The exemplary catalog 800 identifies any limits 804 imposed on the user at location 302 due to restrictions specified in the location profiles 306 for location 302 and for received location 303. The exemplary catalog 800 includes a description 808 for each item 806 in the dynamically created catalog, and exemplary purchasing information 810 for each catalog entry. In depicted illustration 800, the user is a U.S. resident and is over 21 years old (as specified in exemplary illustration 500 of user profile 304). The user may select any quantity of scarf purchases 822, but may only purchase up to 4 liters of wine 824 and up to 2 watches 826. A unit price 810 is presented in each entry of each item in the catalog.

FIG. 9 depicts illustrative contents 900 of an online catalog 340 created for user at location 302 and any received location 303. The exemplary contents 900 of created online catalog 340 confirms the user as an over-19 year-old Canadian resident 901 (as specified in a user profile 304). An input field enables the user to select a quantity 902 of catalog item 906 in order to store the entry of the item into the user's shopping basket 360 in FIG. 3. The exemplary contents 900 of created online catalog 340 also indicates any restrictions 904 imposed on the user at location 302 and at received location 303 due to restrictions specified in location profiles 306 of the current user's location 302 and in user's travel profile 308. The exemplary online catalog 900 created for user at location 302 presents a description 908 for each item in the dynamically created catalog, and the corresponding purchasing information 910 for each item. In the depicted illustration 901, the Canada resident, adult designation is determined by identifying the user's nationality and age from user's profile 304 and the received location 303 from location profile 306. The user can select any quantity of scarf purchases 922, and may purchase up to 4 liters of wine and up to 2 watches from catalog 900.

FIG. 10 depicts illustrative contents 1000 of an online catalog 340 created for user at location 302 and any received location 303. The catalog contents identify the user as a minor 1001. In the depicted illustration 1001, the Canada resident, minor designation is determined by identifying the user's nationality and age (from the user's profile 304), and the location profile 306 (adults are over 19 years old) for received location 303. An input field 1002 enables the user to specify any quantity of a catalog item 1006 in order to place the entry of the item in the user's shopping basket 360 in FIG. 3. The exemplary contents 1000 of online catalog 340 lists limits 1004 imposed on the user at location 302 and received location 303. The exemplary contents 1000 of online catalog 340 presents a description 1008 for each item in the created catalog, and the specific purchasing information 1010 for each item. In the depicted illustration 1000, the minor can specify a maximum quantity of 1 scarf purchase 1022 since in the illustrated exemplary embodiment, location profile 306 for one particular location specifies $75.00 (CAN) maximum purchasing limit by a minor. Catalog provider 320 applies the restrictions of location profile 306 for the one location 303 and the information in the user profile 304 (e.g., Canadian, 14 year-old minor) to limit the items presented in catalog 340 to the identified minor user.

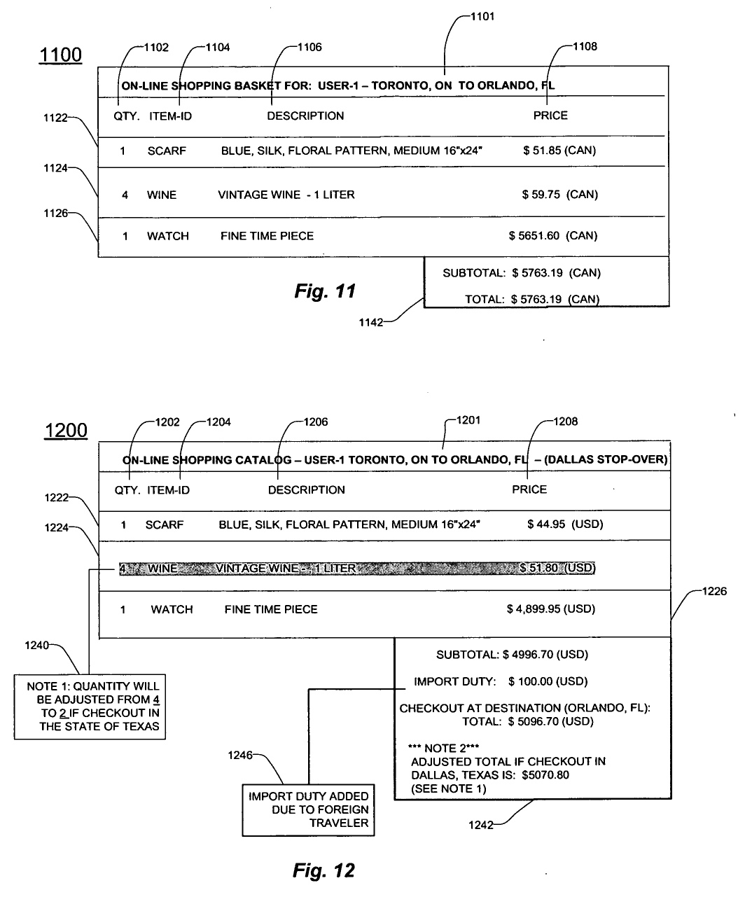

FIG. 11 depicts illustrative contents 1100 of an online shopping basket 360 in FIG. 3 created for an adult user at location 302 after the user has selected the specified entries from catalog 340. The contents 1100 of created shopping basket 360 identifies the user as a traveler from Toronto en-route to Orlando, 1101. A quantity field 1102 presents to the user the selected quantity, and the quantity may be modified by the user within the constraints specified in user profile 304, the location profile 306 for any location 302 and 303, and in travel profile 308. The illustrated exemplary contents 1100 of shopping basket 360 are adjusted with the limits and restrictions imposed on the user at location 302 due to restrictions specified in location profile 306 of any location 302 and 303 and the travel profile 308. The exemplary contents 1100 of online basket 360 presents the selected quantity 1102 of each item 1122, 1124, and 1126, a description 1106 of each item 1122, 1124, and 1126 in the shopping basket, and the specific purchasing information 1108 for each item in the basket. In the depicted illustration 1100, the Toronto to Orlando traveler has selected 1 scarf, 4 liters of vintage wine, and 1 fine watch. A total price 1142 of the items in the shopping basket is presented in denominations of the local currency (i.e., Canadian dollars) as specified in location profile 306 for Toronto location 303.

FIG. 12 depicts illustrative contents 1200 of an online shopping basket 360 in FIG. 3 created for an adult user at location 302 after the user has selected the specified entries from online catalog 340. The contents 1200 of created shopping basket 360 identifies the user as a traveler from Toronto, at a current stop-over in Dallas as a waypoint en-route to the final destination in Orlando, 1201. A quantity field 1202 presents the selected quantity, and the quantity may be modified by the user within the constraints specified in user profile 304, and location profiles 306 for current location 302 and for locations 303 received from travel profile 308. The contents 1200 of shopping basket 360 are adjusted within the limits and restrictions imposed on the user at the current location 302 specified in location profile 306 of the current location 302 (i.e. Dallas, Tex.) and any received location 303. The contents 1200 of online basket 360 created for the user at location 302 presents the selected quantity 1202 of items 1222, 1224, and 1226, a description 1206 of each item 1222, 1224, and 1226, and the specific purchasing information 1208 for each item in the shopping basket. In the depicted illustration 1200, the Toronto to Orlando traveler is currently stopped at the Dallas airport awaiting a plane change en-route to destination 1201. The user has selected 1 scarf 1222, 4 liters of vintage wine 1224, and 1 fine watch 1226. The listing for entry 1224 in sample shopping basket 1200 has been highlighted by catalog provider 340 due to location restrictions specified in a location profile while the traveler is in the State of Texas. An advisory notice 1240 is presented to the user noting that while in the State of Texas the quantity of item 1224 may be adjusted due to restrictions of location profile 306 for the current location 302. Thus, if the user were to checkout the exemplary shopping basket 1200 at Dallas airport, only 2 bottles of fine wine could be purchased as noted in advisory notice 1240. As the user proceeds to Orlando, the advisory notice 1240 is removed since the location profile 306 for Orlando does not have that restriction. In the depicted illustration 1200, in addition to the projected total checkout cost 1242, an advisory message 1246 is presented with the current checkout cost if the user chooses to checkout the shopping basket while at the Dallas airport location 302 and not at the projected final destination location 1206. A total cost 1242 of the items in the shopping basket is presented in denominations of the local currency (i.e., United States dollars) as specified in location profile 306 for Dallas.

The embodiments of the present invention may be implemented on a graphical user interface (GUI), a command-line interface, a menu-driven interface, or any combination of these interfaces. The illustrative examples in the figures are implemented using a graphical user interface in the form of web pages, but may be implemented using other types of graphical user interfaces. These graphical user interfaces include, for example, a client application, an applet, a web based application such as a browser, or a local graphical user interface constructed from a native application, such as a Java 2 platform Micro Edition (J2ME) MIDlet, or an embedded Rich Client Platform (eRCP).

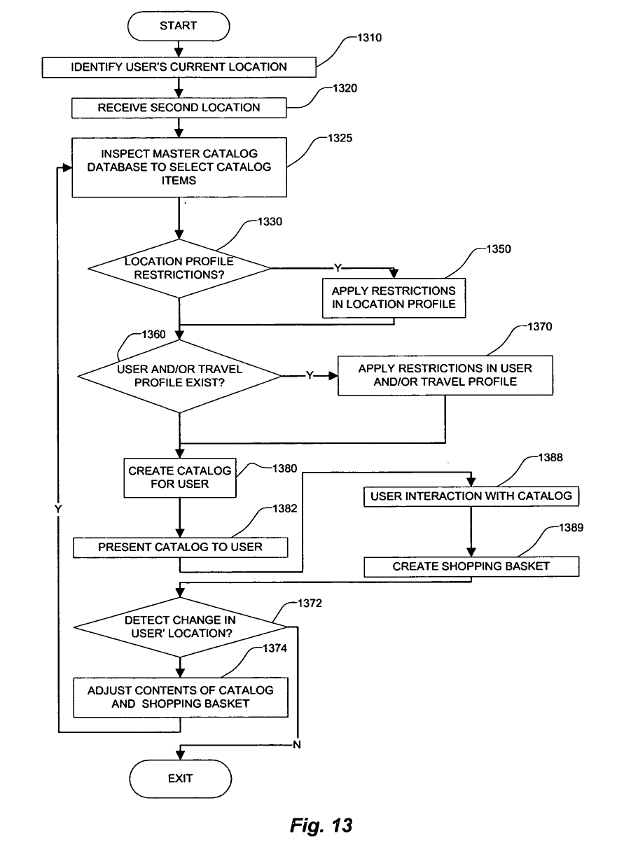

FIG. 13 depicts a flowchart outlining an exemplary operation of the present invention when a catalog provider creates an online catalog for a user through a web page in accordance with an illustrative embodiment of the present invention. This flow shows the steps performed by a catalog provider.

A current location of a user is identified (step 1310). A catalog provider receives a second location (step 1320). The catalog provider uses locations 302 and 303 in FIG. 3 to determine what items to present in the online catalog (step 1325) at location 302. The catalog provider then determines if a location profile 306 in FIG. 3 exists for the user's location 302 and received location 303 (step 1330). If a location profile exists, the catalog provider inspects the location profile to determine if any restrictions apply for any items stored in master catalog database 330 in FIG. 3 with respect to the current location 302 and the received location 303. If any location profile restrictions apply, catalog provider applies restrictions identified in location profile 304 to all entries for items in master catalog database (step 1350). Catalog provider inspects if user's profile 304 and/or travel profile 308 exist to determine if any restrictions apply to the items in the master catalog database for any second location 303 specified in user's travel profile (step 1360). If any user or travel profile restrictions apply, catalog provider applies restrictions in user profile and/or travel profile to all entries of items in master catalog database (step 1370). Catalog provider creates online catalog after applying all restrictions applicable at the identified current location 302 and at received second location 303 (step 1380). The catalog 340 is then presented to the user (step 1382), and the user may select items from the catalog (step 1388), and place the selected items in the shopping basket (step 1389).

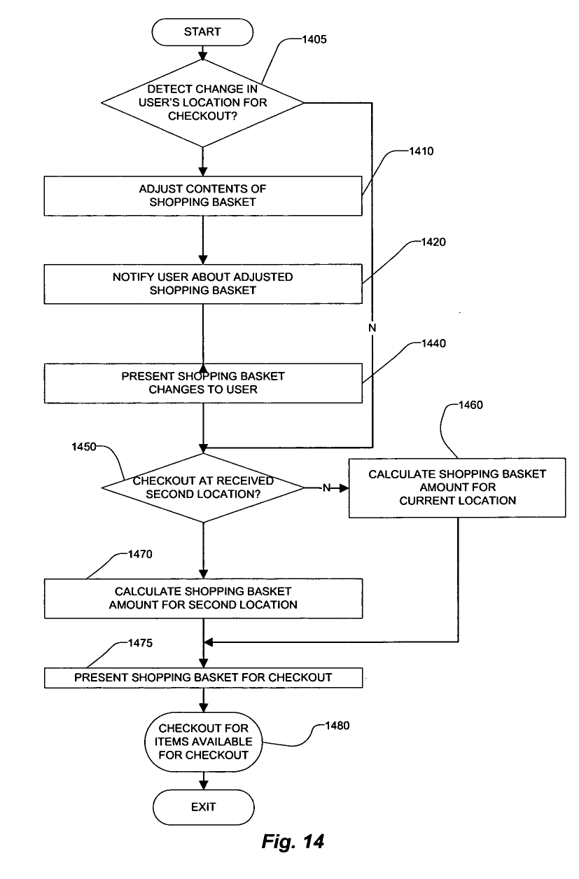

The catalog provider utilizes a user location change detector 390 in FIG. 3 detects a change in the user's current location (step 1372), and adjusts the contents of the online catalog by adding catalog entries not previously presented to the user but which may now be presented, and by removing restricted entries from the online catalog which should not be presented as a result of inspecting the user attributes in user profile 304 as applied to location profile 306 and the user's travel profile 308 with respect to current location 302 and received location 303. Restricted entries in the user's shopping basket are adjusted as described below with reference to FIG. 14 (step 1374).

Once an online catalog is recreated for the user the catalog is again presented to the user via a user interface such as a graphical display or a voice response system (step 1382). The user is then given the option of selecting items from the catalog for storage into the user's shopping basket 360 in FIG. 3. Restrictions for items in the online catalog are applied to each catalog entry, including quantity limits. The user may store items in the user's shopping basket by selecting a quantity of an item the catalog entry (step 1388).

The catalog provider uses the entries selected by the user in order to create the online shopping basket (step 1389).

FIG. 14 depicts a flowchart outlining an exemplary operation of the present invention when a user of an online catalog interacts with an online shopping basket in accordance with an illustrative embodiment of the present invention. This flow shows the steps performed by a checkout operator such as a service provider running on server 104 in FIG. 1.

The online shopping basket may be presented to or modified by the user using an interface such as a graphical user interface or a voice response system. Changes to the shopping basket may be made as long as the modifications are within the constraints placed on the catalog entries for the user.

During the checkout process, a service provider uses location change detector 390 in FIG. 3 to detect a change in the user's current location (step 1405), and adjusts the contents of the online shopping basket by identifying restricted entries from the online shopping basket which are not available for checkout at received location 303 (step 1410).

When an item in the online shopping basket is adjusted due to the applied restrictions in step 1410, a user notification is presented to inform the user about the adjustment made to the shopping basket (step 1420). The specifics of the changes to the shopping basket are presented to the user, and these changes may be identified by highlighting the shopping basket items that correspond to the adjusted content in the shopping basket (step 1440).

A determination is made as to whether the user chooses to checkout at any location 302 other than the received second location 303, for instance at a waypoint location specified in travel profile 308 (step 1450). If so, the shopping basket 360 is updated by the service provider to indicate the contents available for checkout at the current location, and the total price of all the items in the shopping basket is calculated (step 1460). If not, the total price of all the items in the shopping basket is calculated (step 1470). The shopping basket is then presented to the user for checkout (step 1475). A checkout is completed only for items deemed available for checkout at the current location 302 (step 1480). The process then terminates.

A user may be a person traveling or planning to travel from a point of departure to a point of arrival by a carrier conveyance. A user and a traveler can be the same person. However, a user could also be someone other than the traveler. For example, a user could be a travel agent, the traveler's assistant, the traveler's agent, or any other person or organization acting on behalf of the traveler.

Although the present invention has been described primarily with reference to creating a catalog and a shopping basket for an air traveler using an interactive, web based interface, the aspects of the present invention are not limited to creating a catalog for presentation via a website. In other embodiments of the present invention, a catalog may be created by a catalog provider for a specific user, wherein the catalog is printed and mailed to the user. In creating such a printed catalog, the user's current location may be the address to which the catalog is to be mailed, and the second location may be specified by the user or the user's agent or a surrogate user, or it may be determined by inspecting a travel itinerary specified in a travel profile. The interaction with the catalog provider may be accomplished using a telephone voice response system, Short Message Service (SMS), Instant Messaging (IM), or e-mail. A telephone Voice Response System (VRS) can present the user with available online catalog options for selection of catalog entries by using the telephone keypad or word recognition.

Short Message Service (SMS) or Instant Messaging (IM) can be used for presenting online catalogs to users in accordance with the aspects of the present invention. A catalog provider may receive a user's current location via the Short Message Service or Instant Messaging to create a catalog for the user. For example, a menu can be provided to a user with the following pre-selected options: (1) select clothing items; (2) select food stuffs; (3) select jewelry items; and (4) cancel catalog. A user can enter a number on a numeric keypad which corresponds to an option to hear a description of an item, or to select a catalog item, and to store the item in a shopping basket.

The catalog provider maintains a real-time current location of the user utilizing a user location change detector 390 in FIG. 3. The catalog provider utilizes the user location change detector to detect a change in the user's current location, and to subsequently adjust the contents of the online catalog by adding catalog entries not previously presented to the user but which may now be presented, and by removing from the catalog restricted entries which should not be presented based on the user's current location and a received second location. The catalog contents may be adjusted further by inspecting user attributes in the user profile as applied to at least one location profile and the user's travel profile.

The online shopping basket provider maintains a real-time current location of the user using a user location change detector 390 in FIG. 3. The online shopping basket provider utilizes the user location change detector to detect a change in the user's current location, and to subsequently adjust the contents of the online shopping basket by indicating restricted entries selected from the online catalog now stored in the user's shopping basket which are not available for checkout by inspecting the user attributes in the user profile as applied to at least one location profile and the user's travel profile.

The aspects of the present invention permit a catalog provider to create and present a user with an online catalog customized uniquely to the current location of the user. The embodiments of the present invention may be implemented in accordance with a user traveling by airplane, helicopter, train, bus, ship, boat, or any other carrier conveyance.

Because a traveler may log into a carrier's website to request a catalog, the catalog provider may know the traveler's itinerary and can dynamically create an online catalog in accordance with a traveler's arrival and/or departure time and arrival and/or departure location, such as a gate or other waiting area. In addition, the catalog provider can modify a presented catalog due to changes in the current location of the user, such as a change in travel plans, schedule or travel route, anticipated and actual travel stops and waypoints, delays or other changes in a traveler's arrival or departure times and locations. Thus, the aspects of the present invention create a catalog that is uniquely customized to a user based on the user's current location and a received second location, adjusting the contents of the online catalog and any items stored in the user's shopping basket based on location restrictions applicable at the user's current location and the received second location. For example, an underage user will not be presented with an online catalog that contains restricted items for consumption by underage individuals as determined by location restrictions.

The block diagrams and flowcharts in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any other instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and Digital Video/Versatile Disk (DVD).

A data processing system suitable for storing and/or executing program code will include at least one processor coupled directly or indirectly to memory elements through a system bus. The memory elements can include local memory employed during actual execution of the program code, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, wireless Bluetooth and WI-FI network adapters, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention and its practical application, and to enable others of ordinary skill in the art to understand the invention for various embodiments with various modifications as are suited to the particular use contemplated.

What is claimed is:

1. A computer implemented method of dynamically creating a catalog for a user by a catalog provider, the method comprising:
identifying a first location, wherein the first location is a current location of the user;
receiving a second location; and
creating a catalog by the catalog provider, wherein the contents of the catalog are determined based on the identified first location and the received second location.

2. The computer implemented method of claim 1 further comprising presenting the catalog using a format based on the second location.

3. The computer implemented method of claim 1 further comprising:
identifying a changed first location in response to detecting a change in the first location; and
adjusting the contents of the catalog in response to detecting a change in the first location.

4. The computer implemented method of claim 3 wherein adjusting the contents of the catalog further comprises:
adding a catalog entry of an item that is available at the changed first location but not available at the first location; and
removing a catalog entry of an item not available at the changed first location.

5. The computer implemented method of claim 1 further comprising:
identifying at least one attribute associated with the user; and
adjusting the contents of the catalog by the catalog provider in response to identifying at least one attribute associated with the user.

6. The computer implemented method of claim 5, wherein identifying at least one attribute associated with the user comprises identifying at least one property from: a user profile, a location profile, and a travel profile.

7. The computer implemented method of claim 1 further comprising:
selecting at least one entry of an item from the catalog by the user; and
storing the selected at least one entry of an item in an online shopping basket for checkout.

8. The computer implemented method of claim 7 wherein checkout of the online shopping basket is performed at the second location.

9. A system for dynamically creating a catalog for a user by a catalog provider, the system comprising:
means for identifying a first location, wherein the first location is a current location of the user;
means for receiving a second location; and
means for creating a catalog by the catalog provider, wherein the contents of the catalog are determined based on the identified first location and the received second location.

10. The system of claim 9 further comprising means for presenting the catalog using a format based on the second location.

11. The system of claim 9 further comprising:
means for identifying a changed first location in response to detecting a change in the first location; and
means for adjusting the contents of the catalog in response to detecting a change in the first location.

12. The system of claim 11 wherein the means for adjusting the contents of the catalog further comprises:
means for adding a catalog entry of an item that is available at the changed first location but not available at the first location; and
means for removing a catalog entry of an item not available at the changed first location.

13. The system of claim 9 further comprising:
means for identifying at least one attribute associated with the user; and
means for adjusting the contents of the catalog by the catalog provider in response to identifying at least one attribute associated with the user.

14. The system of claim 13, wherein the means for identifying at least one attribute associated with the user comprises means for identifying at least one property from: a user profile, a location profile, and a travel profile.

15. The system of claim 9 further comprising:
means for selecting at least one entry of an item from the catalog by the user; and
means for storing the selected at least one entry of an item in an online shopping basket for checkout.

16. The system of claim 15 wherein checkout of the online shopping basket is performed at the second location.

17. A computer program product comprising:
a computer usable medium including computer usable program code for dynamically creating a catalog for a user by a catalog provider, said computer program product comprising:
computer usable program code for identifying a first location, wherein the first location is a current location of the user;
computer usable program code for receiving a second location; and
computer usable program code for creating a catalog, wherein the contents of the catalog are determined based on the identified first location and the received second location.

18. A computer implemented method of performing checkout of an online shopping basket by a service provider, the method comprising:
identifying a current location of a user requesting checkout of an online shopping basket;
receiving a request for checkout of the shopping basket and the identified location;
determining whether at least one item in the shopping basket of the received request for checkout is available for checkout at the identified current location; and
completing the checkout of the shopping basket for the at least one item in the shopping basket determined to be available for checkout at the identified current location.

19. The computer implemented method of claim 18, further comprising:
determining whether at least one item in the shopping basket is not available for checkout at the identified current location; and
creating a signal to indicate that the at least one item in the shopping basket is not available for checkout in response to determining that at least one item in the shopping basket is not available for checkout at the identified current location.

20. The computer implemented method of claim 19, wherein creating a signal to indicate that the at least one item in the shopping basket is not available for checkout further comprises presenting a message to the user to indicate that the at least one item in the shopping basket is not available for checkout.

21. The computer implemented method of claim 19, further comprising:
calculating a total amount of the shopping basket that includes all of the items in the shopping basket; and
calculating a checkout amount of the shopping basket that includes the items in the shopping basket available for checkout at the identified current location and excludes all of the items in the shopping basket not available for checkout at the identified current location.

22. The method of claim 19, further comprising:
detecting a change in the identified current location of the user;
identifying a changed current location of the user in response to detecting a change in the identified current location of the user; and
adjusting the contents of the shopping basket responsive to identifying a changed current location of the user.

23. The method of claim 22, wherein adjusting the contents of the shopping basket further comprises indicating at least one change in the shopping basket in response to identifying a changed current location of the user.

24. The method of claim 23, wherein indicating at least one change in the shopping basket further comprises:
calculating an updated shopping basket total amount that includes all of the items in the shopping basket; and
calculating an updated checkout amount of the shopping basket amount that includes the items available for checkout at the identified changed current location and excludes the items not available for checkout at the identified changed current location of the user.
